(19) United States
(12) Patent Application Publication
(10) Pub. No.: US 2008/0102807 A1
(43) Pub. Date: May 1, 2008

(54) METHOD AND APPARATUS FOR TERMINATING ALARM SERVICE OF MOBILE TERMINAL

(75) Inventors: Sang Hoon LEE, Gumi-si (KR); Jae Wan PARK, Gumi-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/854,094

(22) Filed: Sep. 12, 2007

(30) Foreign Application Priority Data
Oct. 25, 2006 (KR) 10-2006-0103820

(51) Int. Cl. H04M 11/00

(52) U.S. Cl. 455/418; 455/556.1

(57) ABSTRACT

A method and apparatus for terminating an alarm service of a mobile terminal are provided. The method of terminating an alarm service of a mobile terminal includes determining whether an event monitoring time is included in a set alarm service, determining whether an event is input during the event monitoring time if the event monitoring time is included in the set alarm service, and terminating the set alarm service if the event is input during the event monitoring time.

### CROSS REFERENCE TO RELATED APPLICATION

This application claims priority from and the benefit of Korean Patent Application No. 10-2006-0103820, filed on Oct. 25, 2006, which is hereby incorporated by reference for all purposes as if fully set forth herein.

### BACKGROUND OF THE INVENTION

1. Field of the Invention

The present invention relates to a mobile terminal, and more particularly, to a method and apparatus for terminating an alarm service set in the mobile terminal.

2. Discussion of the Background

Nowadays, manufacturers of mobile terminals provide mobile terminals having various functions (e.g. a camera, MP3, and alarm service) to satisfy the various needs of users.

Among the various functions, an alarm service is a function frequently used by users. An alarm function can be used to remind a user of a specific time (e.g. a morning call, a conference, or a birthday) by outputting an alarm at a set time.

However, in a conventional alarm service, when it is unnecessary to output a set alarm, the user may need to enter a menu for terminating the alarm service to terminate the alarm service.

### SUMMARY OF THE INVENTION

The present invention provides an apparatus and method that provide an alarm service in a mobile terminal, which may be more efficient and convenient to a user.

The present invention also provides an apparatus and method that may terminate an alarm service, without the need for separate key manipulation, by sensing a predetermined event before an alarm output time set in a mobile terminal.

Additional features of the invention will be set forth in the description which follows, and in part will be apparent from the description, or may be learned by practice of the invention.

The present invention discloses a method of terminating an alarm service of a mobile terminal, including determining whether an event monitoring time is included in a set alarm service, determining whether an event is input during the event monitoring time if the event monitoring time is included in the set alarm service, and terminating the set alarm service if the event is input during the event monitoring time.

The present invention also discloses a mobile terminal including an input unit to receive notification of an event and alarm service information and transmit the notification of the event and alarm service information to a controller, a storage unit to store the alarm service information input through the input unit, and a controller to terminate the corresponding alarm service if an event is input during the event monitoring time.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a configuration of a mobile terminal according to an exemplary embodiment of the present invention.

FIG. 2 is a flow chart showing a method of terminating an alarm service of a mobile terminal according to an exemplary embodiment of the present invention.

FIG. 3 is a diagram showing screens for setting an alarm service of a mobile terminal according to an exemplary embodiment of the present invention.

FIG. 4 is a diagram showing screens for terminating an alarm service of a mobile terminal according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

A method of terminating an alarm service of a mobile terminal according to an exemplary embodiment of the present invention may be applied to any device including an alarm service, such as a mobile communication terminal, a mobile phone, a Personal Digital Assistant (PDA), smart phone, a Digital Multimedia Broadcasting (DMB) phone, an MP3 player, a notebook computer, a mobile audio appliances, a mobile television, a digital camera, and applications thereof.

An “event monitoring time” in an exemplary embodiment of the present invention is a time period that is monitored to determine whether an event is input to terminate a set alarm.

The event monitoring time may be input and set as a time period (e.g. ‘30 minutes’), a single specific time (e.g. 06:30), or as two specific times (e.g. 06:30 and 06:45) by a user.

For example, it may be assumed that an alarm output time is set to ‘07:00 A.M.’ in the mobile terminal.

If the event monitoring time is input as a time period such as ‘30 minutes’, the mobile terminal monitors the input of an event from 06:30 A.M., which is ‘30 minutes’ before the alarm output time (07:00 A.M.) to the alarm output time (07:00 A.M.).

If the event monitoring time is input as a single specific time such as ‘06:30 A.M.’, the mobile terminal recognizes the input time as a start time of the event monitoring time and monitors the input of an event from the single specific time (06:30 A.M). to the alarm output time (07:00 A.M.).

If the event monitoring time is input as two specific times such as ‘06:30 A.M.’ and ‘06:45 A.M.’, the mobile terminal monitors the input of an event from 06:30 A.M. to 06:45 A.M., which is the time range between the two specific times. If the input of an event from 06:30 A.M. to 06:45 A.M. is not sensed, the mobile terminal stops monitoring the event and sustains the set alarm service.

An exemplary embodiment of the present invention provides for all three formats of event monitoring times, but for convenience of description, a case where the event monitoring time is set to a specific time period (e.g. ‘30 minutes’) is described below.

In an exemplary embodiment of the present invention, the ‘event’ includes an input signal input by a user. For example, the input signal may be input by opening and closing a folder and slide of a mobile terminal, entering general key input through the input of a touch pad or key pad, or entering a hot key to which an alarm termination function is set.

The event may include a change in the mobile terminal's environment that is input as a signal according to a user's setting, in addition to the input signal input by the user.

For this reason, the mobile terminal may further include an external input sensor including a light sensor or a sound sensor.

If a signal input from the outside is changed, i.e. if a light amount or sound amount input to the light sensor or the sound sensor provided in the mobile terminal is more than a predetermined critical value (e.g. if a lamp, TV, or radio is turned on or if a telephone rings), the mobile terminal may automatically terminate the set alarm service in response to the excess input amount of light and voice compared to the critical value.

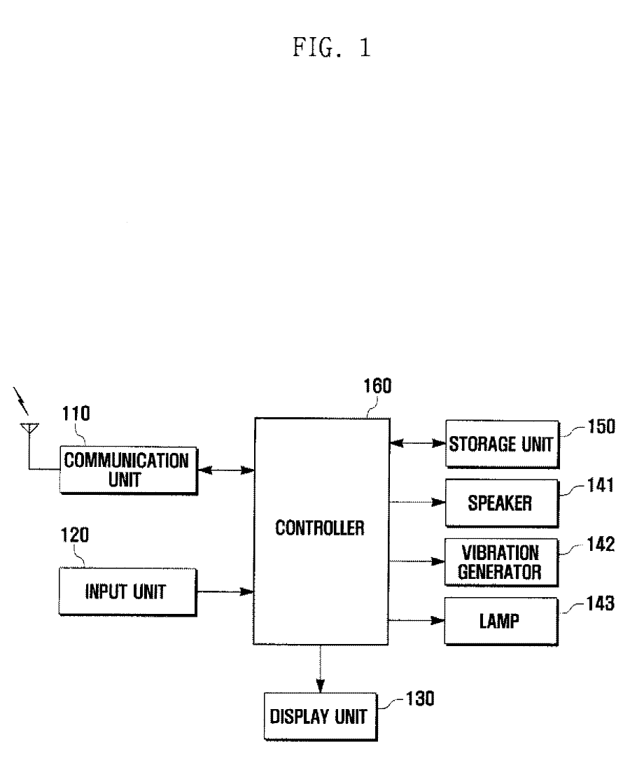

FIG. 1 is a block diagram showing a configuration of a mobile terminal according to an exemplary embodiment of the present invention.

Referring to FIG. 1, the mobile terminal includes a communication unit 110, an input unit 120, a display unit 130, a speaker 141, a vibration generator 142, a lamp 143, a storage unit 150, and a controller 160.

The communication unit 110 includes a radio frequency (RF) transmitter to up-convert a frequency of a signal to be transmitted and amplify the signal, and an RF receiver to low-noise amplify a received signal and down-convert a frequency thereof. The communication unit 110 performs a communication function using a radio communication network.

The input unit 120 is composed of a touch pad or a key pad having various function keys, numeric keys, special keys, and character keys, and transmits an input signal, which may be input by the user to the controller 160, to control the operation of the mobile terminal. Further, the input unit 120 receives alarm service information including an alarm output time, an event monitoring time, and an alarm output method from the user and transmits the alarm service information to the controller 160. The input unit 120 transmits an event input during an event monitoring time to the controller 160.

The display unit 130 is composed of a liquid crystal display (LCD) and displays various data generated in the mobile terminal, as well as a current operation state of the mobile terminal on a screen. Further, the display unit 130 displays a setting screen of the alarm service information including the alarm output time, the event monitoring time, and the alarm output method.

The controller 160 controls the speaker 141, the vibration generator 142, the lamp 143, and the display unit 130 to generate an alarm using a set alarm output method at a set alarm output time.

The storage unit 150 stores programs and data necessary for the general operation of the mobile terminal. Further, the storage unit 150 stores the alarm service information including the alarm output time, the event monitoring time, and the alarm output method input through the input unit 120.

The controller 160 performs the general control operation of the mobile terminal.

Particularly, when an event monitoring time is set in the mobile terminal, the controller 160 monitors whether an event is input during the set event monitoring time. The controller 160 terminates a set alarm service if an event is input during the event monitoring time. When a current time agrees with an alarm output time, the controller 160 outputs an alarm according to the set alarm service. The controller 160 controls the mobile terminal to output an alarm using a set alarm output method at the set alarm output time.

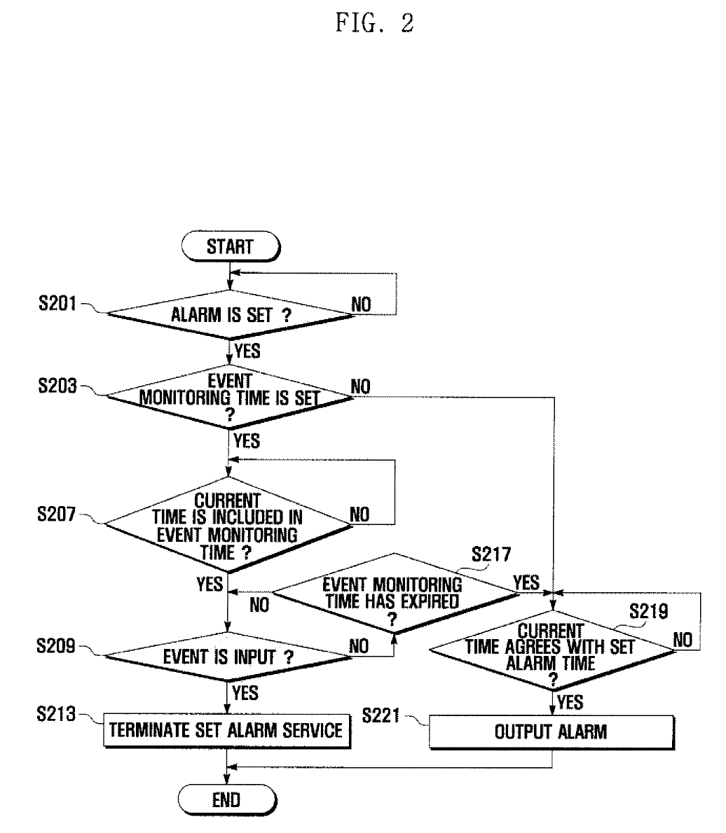

FIG. 2 is a flow chart showing a method of terminating an alarm service of a mobile terminal according to an exemplary embodiment of the present invention.

Referring to FIG. 1 and FIG. 2, the controller 160 determines whether an alarm service is set in the mobile terminal (S201). When an alarm service is set in the mobile terminal, the controller 160 determines whether an event monitoring time is set in the mobile terminal (S203).

The “event monitoring time” is a time period that is monitored to determine whether a predetermined event is input in order to terminate the set alarm service. The event monitoring time can be set as a time period (e.g. 30 minutes). Further, the event monitoring time may be set as a single specific time (e.g. 06:30) or two specific times (e.g. 06:30 and 07:00).

If an event monitoring time is not set in the mobile terminal, the controller 160 performs the general alarm service process by entering steps S219 and S221.

The general alarm service process includes a process in which the controller 160 determines whether the current time agrees with a set alarm output time (S219) and a process in which the controller 160 outputs an alarm when the current time agrees with a set alarm output time (S221).

If an event monitoring time is set in the mobile terminal at step S203, the controller 160 determines whether the current time is included in the event monitoring time (S207).

When the current time is included in the event monitoring time, for example if the current time is 06:49 A.M. and is thus included in the event monitoring time (from 6:30 A.M. to 7:00 A.M.), the controller 160 determines whether an event has been detected or input by the user (S209).

If an event is input by the user, the controller 160 terminates the set alarm service (S213). If an event is not input by the user, the controller 160 determines whether the event monitoring time has expired (S217).

If the event monitoring time has expired, the controller 160 performs the described general alarm service process by entering steps S219 and S221.

If the event monitoring time has not expired, the controller 160 determines whether an event is input by returning to step S209.

As described above, in an exemplary embodiment of the present invention, if a specific event is input during an event monitoring time, a set alarm service is terminated, however a set alarm service is not terminated when an exceptional event is input. That is, an alarm service may be selectively terminated depending on the kind of event that is input. For example, a communication connection and ending request signal from a user, or a receipt and transmission request signal of a character message, may be set as an exceptional event that does not terminate an alarm service.

Thereafter, if an event is input during an event monitoring time, the controller 160 determines whether the input event is an exceptional event that does not terminate the alarm service.

If the input event is an exceptional event that does not terminate the alarm service, the controller 160 sustains an alarm state. That is, the controller 160 monitors whether a new event related to termination of the alarm service is input during an event monitoring time while sustaining the alarm service. If the input event is an event for terminating alarm service, the controller 160 performs a function corresponding to the input event and terminates the set alarm service.

In an exemplary embodiment of the present invention, a message asking whether to terminate the set alarm service may be displayed before terminating the set alarm service at step S213 and an alarm service may be sustained or terminated according to an input signal of the user in order to prevent an alarm service from being terminated unintentionally. For example, if a signal for requesting to sustain the set alarm service is input, the controller 160 sustains an alarm service, and if a signal requesting termination of the set alarm service is input, the controller 160 terminates the set alarm service.

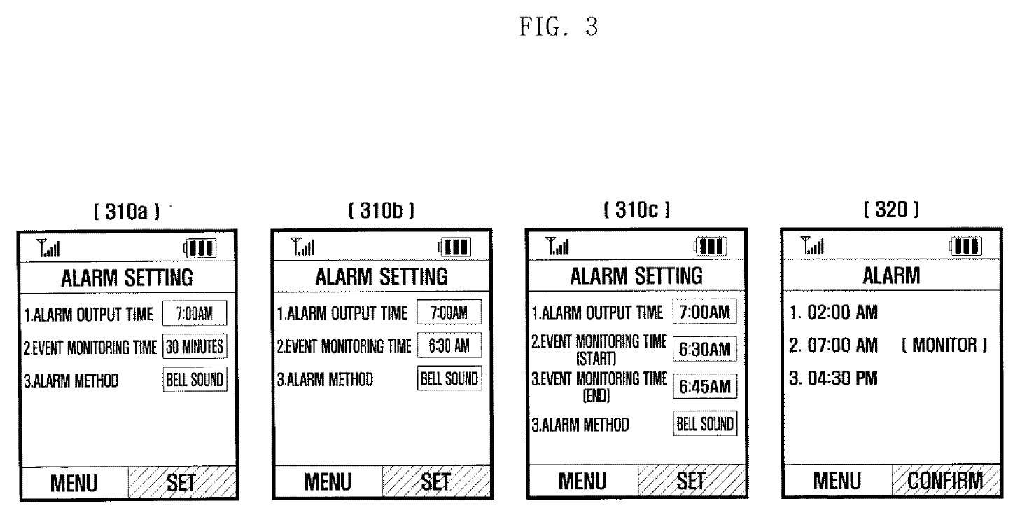

FIG. 3 is a diagram showing screens for setting an alarm service of a mobile terminal according to an exemplary embodiment of the present invention.

As shown in screens 310a, 310b, and 310c, the mobile terminal receives information to set an alarm service from a user. An alarm output time is a time at which an alarm in the mobile terminal is output, and in an example of the present invention, 07:00 A.M. is set as the alarm output time. An event monitoring time is a time period that is monitored to determine whether a predetermined event is input to terminate the set alarm service.

The event monitoring time may be set as a time period (e.g. 30 minutes) as in screen 310a, as a single specific time (e.g. 06:30) as in screen 310b, or as two specific times (e.g. 06:30 and 06:45) as in screen 310c.

For example, if the event monitoring time is input as a time period like ‘30 minutes’ as in the screen 310a, the mobile terminal monitors the input of an event from 06:30 A.M., which is 30 minutes before the alarm output time (07:00 A.M.), to the alarm output time (07:00 A.M.).

If the event monitoring time is input as a single time like “06:30 A.M.” as in screen S310b, the mobile terminal recognizes 06:30 A.M. as a start time of an event monitoring time and monitors the input of an event from the start time (06:30 A.M.) to the alarm output time (07:00 A.M.).

If the event monitoring time is input as two specific times like “06:30 A.M.” and “06:45 A.M.” as in screen 310c, the mobile terminal monitors the input of an event from 06:30 A.M. to 06:45 A.M., which is the range between the two input times. If the input of an event is not sensed during 15 minutes from 06:30 A.M. to 06:45 A.M., the mobile terminal stops monitoring the event and sustains the set alarm service.

An alarm output method is a method of outputting an alarm at the alarm output time, and in the exemplary embodiment of the present invention shown in FIG. 3, a bell sound is set as an alarm output method.

Thereafter, if a setting key is input by a user, the mobile terminal displays the alarm service that is currently set as in screen 320 and indicates an alarm service in which an event monitoring time is set among alarm services displayed in screen 320, i.e. “2. 07:00 A.M. (monitor)”.

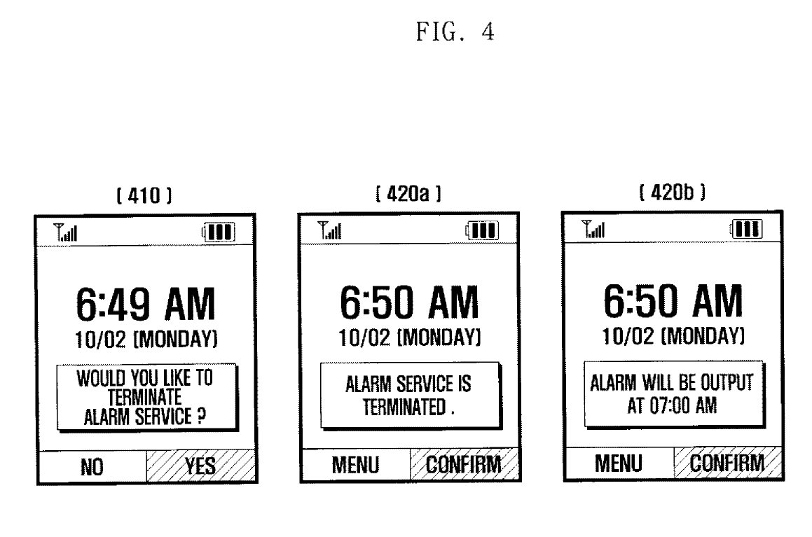

FIG. 4 is a diagram showing screens for terminating an alarm service of a mobile terminal according to an exemplary embodiment of the present invention.

The mobile terminal monitors whether an event is input from an event monitoring time (30 minutes) of an alarm output time (07:00 A.M.) to an alarm output time (07:00 A.M.). That is, the mobile terminal monitors whether an event is input from 06:30 A.M. to 07:00 A.M.

If an event is input at a current time 6:49 A.M., the mobile terminal displays a message of “Would you like to terminate alarm service?” as in the screen 410 in order to prevent an alarm service from being terminated unintentionally. Further, the present invention includes an exemplary embodiment in which an alarm may be terminated automatically without displaying the message indicating whether to terminate an alarm service as in screen 410.

If a ‘Yes’ key is input, the mobile terminal terminates an alarm service and displays the message of “Alarm service is terminated.” as in screen 420a.

If a ‘No’ key is input, the mobile terminal sustains an alarm state, and displays the message of “Alarm will be output at 07:00 A.M.” as in screen 420b.

In another exemplary embodiment of the present invention, if an event is input during an event monitoring time, the mobile terminal may immediately terminate an alarm service without asking whether to terminate an alarm service to a user.

In this case, in order to prevent an alarm service from being terminated unintentionally, the controller 160 may count the number of times an event is input and may terminate the preset alarm service if the number of times the event is input is greater than or equal to a preset number.

For example, in a mobile terminal in which the preset number is set to three and an event is input three or more times during the event monitoring time, the set alarm service is terminated.

As described above, according to the present invention, an alarm service set in the mobile terminal may be efficiently and conveniently provided to a user.

Further, an alarm service may be terminated without the need for separate key manipulation by sensing event input before a set alarm output time in the mobile terminal.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of terminating an alarm service of a mobile terminal, comprising:
determining whether an event monitoring time is included in a set alarm service;
determining whether an event is input during the event monitoring time if the event monitoring time is included in the set alarm service; and
terminating the set alarm service if the event is input during the event monitoring time.

2. The method of claim 1, wherein the event monitoring time is set using at least one of a time period format, a format displaying a monitoring start time, and a format displaying a monitoring start time and a monitoring end time.

3. The method of claim 1, wherein the alarm service comprises an alarm output time, an event monitoring time, and an alarm output method.

4. The method of claim 3, wherein the event monitoring time ends before the alarm output time.

5. The method of claim 1, further comprising outputting an alarm with a set alarm output method at a set alarm output time if the event monitoring time is not included in the set alarm service.

6. The method of claim 1, wherein the event comprises an external input signal.

7. The method of claim 6, wherein the external input signal comprises at least one of opening and closing a folder and slide of the mobile terminal, input of a touch pad and key pad, and input of a change in the environment of the mobile terminal.

8. The method of claim 1, wherein the event comprises an external input signal to terminate the alarm service.

9. The method of claim 1, wherein terminating the set alarm service comprises:
displaying a message to inquire whether the set alarm service is to be terminated;
receiving input information corresponding to the displayed message; and
terminating the set alarm service or sustaining the set alarm service according to the received input information.

10. The method of claim 9, wherein terminating the set alarm service further comprises:
counting the number of times the event is input; and
terminating the set alarm service if the counted number of times the event is input is greater than or equal to a preset number.

11. The method of claim 1, further comprising sustaining the set alarm service if the event is not input during the event monitoring time.

12. A mobile terminal comprising:
an input unit to receive notification of an event and alarm service information and transmit the notification of the event and alarm service information to a controller;
a storage unit to store the alarm service information input through the input unit; and
a controller to terminate the corresponding alarm service if an event is input during an event monitoring time.

13. The mobile terminal of claim 12, wherein the alarm service information comprises an alarm output time, an event monitoring time, and an alarm output method.

14. The mobile terminal of claim 12, further comprising a display unit to display a setting screen to set the alarm service.

15. The mobile terminal of claim 12, further comprising an external input sensor to sense a change in the environment of the mobile terminal.

16. The mobile terminal of claim 15, wherein the external input sensor comprises a light sensor to sense a change in an amount of light or a sound sensor to sense a change in an amount of sound.

17. The mobile terminal of claim 12, wherein the event monitoring time is a time to monitor the input of an event to automatically terminate the set alarm service.
